(19) United States
(12) Patent Application Publication
(10) Pub. No.: US 2015/0100434 A1
(43) Pub. Date: Apr. 9, 2015

(54) BARTERING CONTENT FOR APPLICATION DEVELOPERS

(71) Applicant: Apple Inc., Cupertino, CA (US)

(72) Inventors: Mehul K. Sanghavi, Sunnyvale, CA (US); Michael Froimowitz Greenzeiger, Sunnyvale, CA (US); Ravindra Phulari, San Jose, CA (US)

(73) Assignee: Apple Inc., Cupertino, CA (US)

(21) Appl. No.: 14/048,433

(22) Filed: Oct. 8, 2013

(51) Int. Cl. G06Q 30/02

(52) U.S. Cl. CPC G06Q 30/0273
USPC 705/14.69

(57) ABSTRACT

Systems, methods, and computer-readable storage media for bartering content. The system adds a first application to a bartering network, the bartering network including applications for exchanging objects, each of the objects including content associated with a specific application and available for integration into a different application. The system then assigns an application value to the first application and determines an exchange rate for exchanging at least a first object for integration into a second application with at least a second object for integration into the first application, wherein the exchange rate is based on the application value. Based on the exchange rate, the system exchanges the at least first object with the at least second object to yield an exchange, wherein the exchange enables the at least first object to be integrated into the second application and the at least second object to be integrated into the first application.

### TECHNICAL FIELD

The present technology pertains to advertising, and more specifically pertains to bartering advertising impressions for application developers.

### BACKGROUND

Online advertising is widely used by application developers as a means for developers to monetize their applications via display banners and interstitials. Online advertising is also used by developers to induce potential customers to download their applications. Many times, application developers will pay a fee to have their application advertised in other applications, developed by other developers. By advertising their applications through other applications, developers can greatly enhance their advertising reach and performance, as they can benefit from the demographics, reputation, and advertising reach of the other applications. However, the fees for advertising in other applications can be high, particularly as the value, reputation, and popularity of the other applications increase.

Unfortunately, smaller application developers generally do not have a lot of resources. Consequently, smaller application developers are unable to pay the fees to have their applications advertised through other applications, particularly if they are not already receiving income from advertising within their own application. Moreover, even larger application developers are often unwilling, or unable, to pay the fees required to advertise their applications through other applications. Thus, given the rigidity, restrictiveness, and unfeasibility of the current strategies for online advertising, a significant number of application developers are frequently limited in their advertising options, and, disadvantageously, many are unable to advertise their applications through other applications. Yet a single developer's inability to advertise her application through another application can have wide-ranging implications: the developer's inability to advertise through another application can have a negative impact on every party involved, including the developer of the application to be advertised, the developer of the application to be used for advertising, and the consumers affected by the limited advertising.

### SUMMARY

Additional features and advantages of the disclosure will be set forth in the description which follows, and in part will be obvious from the description, or can be learned by practice of the herein disclosed principles. The features and advantages of the disclosure can be realized and obtained by means of the instruments and combinations particularly pointed out in the appended claims. These and other features of the disclosure will become more fully apparent from the following description and appended claims, or can be learned by the practice of the principles set forth herein.

The approaches set forth herein can be used to barter advertising (“ad”) impressions for application developers. Here, application publishers of all sizes and categories can barter among each other for ad impressions for their respective applications. These approaches can provide much flexibility, allowing any developer to advertise her application through other applications, even if she does not have a lot of resources. Application developers can advertise any content, including applications, standalone content items, and even “freemium” content within applications that other developers and/or publishers own. These approaches can take into account how to value ad impressions within different applications to help developers when bartering with each other. Here, applications can be valued relative to each other, for example, to ensure a fair balance of value given and received between bartering parties. An ad network can be used to manage bartering transactions to ensure that the bartering occurs seamlessly and that every advertiser and/or developer meets her commitments.

Disclosed are devices, systems, methods, and non-transitory computer-readable storage media for bartering content for online advertising. The system can add a first application to a bartering network of applications, the bartering network of applications including a pool of applications for exchanging associated objects, wherein each of the associated objects includes content associated with a specific application and available for integration into a different application. The first application can include a software application, a web page, a media file, and/or any other content. Similarly, the associated objects can include a software application, a web page, a media file, and/or any other content. For example, the associated objects can be associated advertisements, which can include, for example, banners, interstitials, videos, images, audio content, etc. When adding the first application to the bartering network of applications, the system can assign the first application to an application category based on one or more factors, such as the type of application of the first application, the title of the first application, the value of the first application, the owner and/or developer of the first application, a characteristic of the first application, a popularity of the first application, a subject of the first application, a performance of the first application, a timestamp, etc.

The system can then assign an application value to the first application based on a characteristic associated with the first application. The application value can be, for example, an intrinsic value of the first application. The intrinsic value can be based on a value of impressions associated with the first application. The intrinsic value can also be based on a performance of advertisements associated with the first application. The characteristic associated with the first application, which can be used to assign the bartering value, can be based on one or more factors, such as a number of impressions per unique user, demographics, an application category, a historical tendency of users who have downloaded a separate application through the first application to purchase content associated with the separate application, a targeting parameter, a total lifetime user spend value associated with the first application, a popularity of the first application, profits associated with the first application, the owner and/or developer of the first application, preferences, ratings, advertising history, application type, reputation, etc.

Next, the system can determine an exchange rate for exchanging at least a first object associated with the first application for integration into a second application, with at least a second object associated with the second application for integration into the first application, wherein the exchange rate is based on the application value. The exchange rate can be an objective ratio determined based on the application value. The exchange rate can be a ratio for an exchange determined by the system, and, in some cases, does not necessarily have to be an exchange rate that either the first application or the first application are willing to accept. Rather, the exchange rate can be the ratio of exchange suggested and/or prescribed by the bartering system.

In some embodiments, the exchange rate can be for exchanging at least the first object for display at the second application with at least the second object for display at the second application. Moreover, the exchange rate can be static, or it can be dynamic and/or updated periodically. For example, the exchange rate can be updated based on performance. In some embodiments, the exchange rate is based on an intrinsic valuation of applications. However, in other embodiments, the exchange rate can be based on a download-for-download valuation system. In still other embodiments, the exchange rate can be a hybrid of the intrinsic valuation system and the download-for-download valuation system. Other valuation systems, such as one-to-many valuation systems, asymmetric valuation systems, group valuation systems, discount valuation systems, blind valuation systems, etc., are contemplated herein. The above, non-limiting examples are provided for illustration purposes.

Next, based on the exchange rate, the system can exchange the at least first object with the at least second object to yield an exchange, wherein the exchange enables the at least first object to be integrated into the second application and the at least second object to be integrated into the first application. In some cases, the exchange can be for exchanging the at least first object for display at the second application with the at least second object for display at the first application. Here, the exchange can enable the at least first object to be displayed at the second application and the at least second object to be displayed at the first application. Thus, the owner and/or developer of the first application can have the first application and/or any object/content associated with the first application displayed at the second application, in exchange for displaying, at the first application, the second application and/or an object/content associated with the second application. In some embodiments, the system proposes the exchange but does not complete the exchange unless it receives permission from the owner's and/or developers associated with the first and second applications. In other embodiments, the exchange is automatic and does not require input and/or permission from the owner's and/or developers of the first and second application.

In exchanging the at least first object with the at least second object, the system can manage a bartering transaction between trading partners. For example, the system can manage the exchange of promises, the agreement, the items exchanged, the trading inventory, the valuation process and procedures, the bartering network of applications, the transmission of the items exchanged, the conditions of the exchange, the payments exchanged, the enforcement of any conditions of the exchange, the monitoring of the exchange, the communications associated with the exchange, the mediation of the exchange and/or any disagreements, the troubleshooting of problems associated with the exchange, and/or any other aspect of the exchange. For example, as the managing entity of the bartering transaction, the system can send the first application and/or the at least first object to the second application and/or a device associated with an owner/developer of the second application, for display at, or integration into, the second application. Likewise, the system can send the second application and/or the at least second object to the first application and/or a device associated with an owner/developer of the first application, for display at, or integration into, the first application.

Indeed, prior to the actual bartering transaction, the system can identify an intent by the parties to engage in the exchange. The system can subsequently manage any bartering exchange that takes place between the parties. The intent can be based on the application value of the applications, specific groupings and/or categories of the parties, specific categories of the applications, a bartering history, a bartering request, an offer, etc. Moreover, the system can also identify the trading partners in a bartering transaction, as well as any prospective trading partners. Trading partners can be identified by the system via an application bank. The application bank can have different applications and/or groups of different applications. For example, the applications in the application bank can be grouped based on one or more factors, such as respective profiles, respective functionalities, respective characteristics, respective values, respective performances, respective profits earned, respective subjects, respective owners/developers, respective topics, respective content, respective relationships, respective popularities, respective reputations, respective nationalities, respective origins, respective classifications, respective ratings, prior transactions, etc. The trading partners can be associated with the first application, the second application, and/or any other applications and content. The system can also identify the second application, and any other application, for the exchange. The system can identify one or more applications for the exchange based on the application value of the first application, the application value of the application(s) involved in the exchange, and/or one or more factors associated with any of the applications in the exchange, such as an application category, an application performance, a reputation, a profit, a performance, a rating, a transaction history, an owner/developer, etc.

In some embodiments, the exchange can be between multiple trading partners. For example, the exchange can be between two or three trading partners. In some cases, the exchange can also be between groups of trading partners. For example, the exchange can be between a group of trading partners associated with an application suite, and another group of trading partners associated with an application suite. Moreover, the exchange between the trading partners can be asymmetric. For example, App A can serve or display an Ad for App B in exchange for App C serving or displaying an Ad for App A. App C can also serve or display the Ad for App A in exchange for App A, App B, and/or App D serving or displaying the Ad for App C. Here, the trading partners associated with one or more of the applications can be different. Thus, the exchange can involve multi-party asymmetric transactions, as previously mentioned.

In addition, the exchange can be for different objects. For example, the exchange can be for different types of objects, different number of objects, etc. To illustrate, the at least first object can be a banner, whereas, by contrast, the at least second object can be an interstitial. Thus, here, the exchange can be between a banner and an interstitial, as opposed to a banner and a banner, or an interstitial and an interstitial. As another example, the at least first object can be multiple objects, such as two banners and a pop-up ad, and the at least second object can be a single interstitial. Thus, in this example, the exchange would be between three objects and one object.

### BRIEF DESCRIPTION OF THE DRAWINGS

In order to describe the manner in which the above-recited and other advantages and features of the disclosure can be obtained, a more particular description of the principles briefly described above will be rendered by reference to specific embodiments thereof which are illustrated in the appended drawings. Understanding that these drawings depict only exemplary embodiments of the disclosure and are not therefore to be considered to be limiting of its scope, the principles herein are described and explained with additional specificity and detail through the use of the accompanying drawings in which:

FIG. 1 illustrates an exemplary configuration of devices and a network;

FIG. 2 illustrates an exemplary architecture for bartering content;

FIG. 3 illustrates an exemplary content bartering system;

FIG. 4 illustrates an exemplary bartering exchange of objects;

FIG. 5 illustrates an exemplary bartering table for bartering advertising impressions;

FIG. 6 illustrates an exemplary method embodiment;

FIG. 7 illustrates an exemplary flowchart for bartering content; and

FIGS. 8A and FIG. 8B illustrate exemplary system embodiments.

### DESCRIPTION

Various embodiments of the disclosure are discussed in detail below. While specific implementations are discussed, it should be understood that this is done for illustration purposes only. A person skilled in the relevant art will recognize that other components and configurations may be used without parting from the spirit and scope of the disclosure.

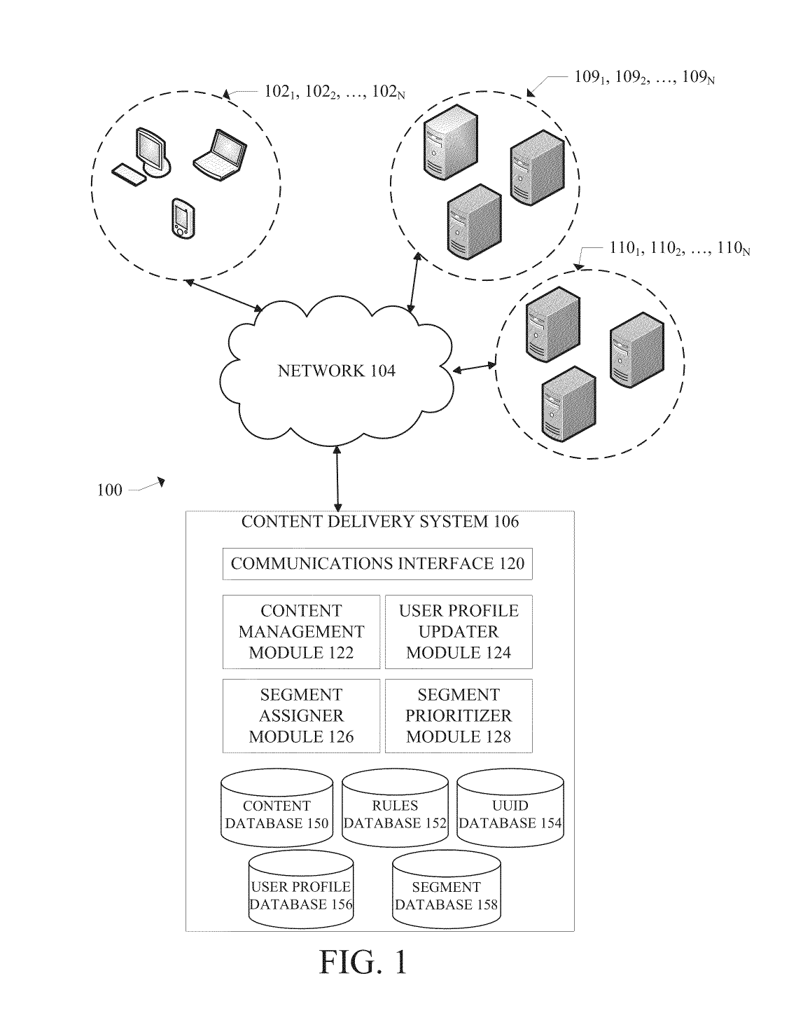

The disclosed technology addresses the need in the art for flexible, effective and more feasible online advertising. Disclosed are systems, methods, and non-transitory computer-readable storage media for bartering content for online advertising. A brief introductory description of an exemplary configuration of devices and a network is disclosed herein. A detailed description of bartering content for online advertising, and exemplary variations will then follow. These variations shall be described herein as the various embodiments are set forth. The disclosure now turns to FIG. 1.

An exemplary system configuration 100 is illustrated in FIG. 1, wherein electronic devices communicate via a network for purposes of exchanging content and other data. The system can be configured for use on a wide area network such as that illustrated in FIG. 1. However, the present principles are applicable to a wide variety of network configurations that facilitate the intercommunication of electronic devices. For example, each of the components of system 100 in FIG. 1 can be implemented in a localized or distributed fashion in a network.

In system 100, invitational content can be delivered to user terminals 102₁, 102₂, . . . , 102ₙ (collectively “102”) connected to a network 104 by direct and/or indirect communications with a content delivery system 106. User terminals 102 can be any network enabled client devices, such as desktop computers; mobile computers; handheld communications devices, e.g. mobile phones, smart phones, tablets; smart televisions; set-top boxes; and/or any other network enabled computing devices. Furthermore, content delivery system 106 can concurrently accept connections from and interact with multiple user terminals 102.

The content delivery system 106 can receive a request for electronic content, such as a web page, an application, a media item, etc., from one of user terminals 102. Thereafter, the content delivery system 106 can assemble a content package and transmit the assembled content page to the requesting one of user terminals 102. To facilitate communications with the user terminals 102 and/or any other device or component, the content delivery system 106 can include a communications interface 120.

The content delivery system 106 can include a content management module 122 to facilitate the generation of an assembled content package. Specifically, the content management module 122 can combine content from one or more primary content providers 109₁, 109₂, . . . , 109ₙ (collectively “109”) and content from one or more secondary content providers 110₁, 110₂, . . . 110ₙ (collectively “110”) to generate the assembled content package for the user terminals 102. For example, in the case of a web page being delivered to a requesting one of user terminals 102, the content management module 122 can assemble a content package by requesting the data for the web page from one of the primary content providers 109 maintaining the web page. For the invitational content on the web page provided by the secondary content providers 110, the content management module 122 can request the appropriate data according to the arrangement between the primary and secondary content providers 109 and 110. Additionally, the content management module 122 can create content packages that contain content from a single content provider. That is, a content package can contain only primary content or a content package can contain only secondary content. However, the content package is not limited to the content from content providers 109 and 110. Rather, the content package can include other data generated at the content delivery system 106. In some embodiments, the content delivery system 106 can preselect the content package before a request is received.

An assembled content package can include text, graphics, audio, video, executable code, or any combination thereof. Further, an assembled content package can include invitational content designed to inform or elicit a pre-defined response from the user. In some embodiments, the invitational content can be associated with a product or can directly or indirectly advertise a product. For example, the assembled content package can include one or more types of advertisements from one or more advertisers.

Additionally, the invitational content can be active invitational content. That is, invitational content that is designed to primarily elicit a pre-defined response from a user. For example, active invitational content can include one or more types of advertisements configured to be clicked upon, solicit information, or be converted by the user into a further action, such as a purchase or a download of the advertised item. However, invitational content can also be passive invitational content. That is invitational content that is designed to primarily inform the user, such as a video. In some cases, passive invitational content can include information that can lead or direct users to other invitational content including active invitational content.

Furthermore, the invitational content can be dynamic invitational content. That is invitational content that varies over time or that varies based on user interaction. For example, dynamic invitational content can include an interactive game. However, the various embodiments are not limited in this regard and the invitational content can include static invitational content that neither varies over time nor with user interaction. In the various embodiments, invitational content in a content package can be static or dynamic and active or passive. A content package can include a combination of various types of invitational content in a single content package.

In some cases, a content package can replace or update invitational content in a content package already delivered to a user terminal. For example, a first content package can include an app that can be installed on the user terminal 102ᵢ. A subsequent content package can include one or more items of invitational content that can be presented to a user of the user terminal 102ᵢ while the user interacts with the app.

Although primary and secondary providers 109 and 110 are presented herein as separate entities, this is for illustrative purposes only. In some cases, the primary and the secondary content providers 109 and 110 can be the same entity. Thus, a single entity can provide both the primary and the secondary content.

The content management module 122 can be configured to request that content be sent directly from content providers 109 and 110. Alternatively, a cached arrangement can also be used to improve performance of the content delivery system 106 and improve overall user experience. That is, the content delivery system 106 can include a content database 150 for locally storing/caching content maintained by content providers 109 and 110. The data in the content database 150 can be refreshed or updated on a regular basis to ensure that the content in the database 150 is up to date at the time of a request from a user terminal 102ᵢ. However, in some cases, the content management module 122 can be configured to retrieve content directly from content providers 109 and 110 if the metadata associated with the data in the content database 150 appears to be outdated or corrupted.

As described above, content maintained by the content providers 109 and 110 can be combined according to a predefined arrangement between the two content providers, which can be embodied as a set of rules. In an arrangement where the content delivery system 106 assembles the content package from multiple content providers, the assembly rules can be stored in a rules database 152 in the content delivery system 106. The content management module 122 can be configured to assemble the content package for user terminals 102 based on these rules. The rules can specify how to select content from secondary content providers 110 and primary content providers 109 in response to a request from one of user terminals 102. For example, in the case of a web page maintained by one of primary content providers 109 and including invitational content, the rules database 152 can specify rules for selecting one of the secondary providers 110. The rules can also specify how to select specific content from the selected one of secondary providers 110 to be combined with the content provided by one of primary providers 109. In some cases, an item of primary content, such as an app or other media object, can have one or more associated attributes. For example, an app can have one or more associated genre attributes, e.g. travel, sports, education, etc. A rule can be based at least in part on the primary content attributes. Once assembled, the assembled content package can be sent to a requesting one of user terminals 102.

Additionally, rules for combining primary and secondary content can be based on user characteristics known about the user. In particular, in some cases, invitational content can be selected based on the characteristics of the requesting user(s). As used herein, the term “user characteristics” refers to the characteristics of a particular user associated with one or more of user terminals 102. User characteristics can include channel characteristics, demographic characteristics, behavioral characteristics, and spatial-temporal characteristics. Channel characteristics can define the specific delivery channel being used to deliver a content package to a user. For example, channel characteristics can include a type of electronic content, a type of device or user terminal, a carrier or network provider, or any other characteristic that defines a specific delivery channel for the content package. Spatial-temporal characteristics can define a location, a location zone, a date, a time, or any other characteristic that defines a geographic location and/or a time for delivery of the content package. Demographic characteristics can define characteristics of the users targeted by the content or associated with the content. For example, demographic characteristics can include age, income, ethnicity, gender, occupation, or any other user characteristics. Behavioral characteristics can define user behaviors for one or more different types of content, separately or in combination with any other user characteristics. That is, different behavioral characteristics may be associated with different channel, demographic, or spatial-temporal characteristics. User characteristics can also include characteristics descriptive of a user's state of mind including characteristics indicative of how likely a user is to click on or convert an item of invitational content if it were displayed to the user. User characteristics can be learned directly or derived indirectly from a variety of sources. In some embodiments, the user characteristic values can be collected from one or more databases. For example, if the user is registered with an online media service, such as the ITUNES store maintained by Apple Inc. of Cupertino, Calif., the collected data could include the user's registration information. Such data can provide values for declared user characteristics. Furthermore, the content delivery system 106 can be configured to learn of or derive user characteristics from any number of other information sources. For example, in some configurations, the content delivery system 106 can derive or infer one or more user characteristic values from user characteristic values already known about the user.

In some embodiments, the interactive content can be associated with one or more targeted segments. A targeted segment can be viewed as defining a space or region in k-dimensional space, where each of the k dimensions is associated with one of a plurality of user characteristics. In the various embodiments, the k dimensions can include both orthogonal and non-orthogonal dimensions. That is, some of the k dimensions can overlap or can be related in some aspect.

In the various embodiments, the content delivery system 106 can also include a unique user identifier (UUID) database 154 that can be used for managing sessions with the various user terminal devices 102. The UUID database 154 can be used with a variety of session management techniques. For example, the content delivery system 106 can implement an HTTP cookie or any other conventional session management method (e.g., IP address tracking, URL query strings, hidden form fields, window name tracking, authentication methods, and local shared objects) for user terminals 102 connected to content delivery system 106 via a substantially persistent network session. However, other methods can be used as well. For example, in the case of handheld communications devices, e.g. mobile phones, smart phones, tablets, or other types of user terminals connecting using multiple or non-persistent network sessions, multiple requests for content from such devices may be assigned to a same entry in the UUID database 154. The content delivery system 106 can analyze the attributes of requesting devices to determine whether such requests can be attributed to the same device. Such attributes can include device or group-specific attributes.

In some embodiments, the content delivery system 106 can include a user-profile database 156. The user-profile database 156 can, at least in part, be constructed based on declared user characteristics related to one or more users. In some cases, the user-profile database may contain inferred or derived user characteristic values. The user-profile database 156 can be updated using a user-profile-updater module 124. In some embodiments, the user-profile-updater module 124 can be configured to add additional profile data, update profile data, fill in missing profile data, or infer user characteristic values from declared data.

The user-profile-updater module 124 can also be configured to maintain the user profile database 156 to include only more recently acquired data or to re-derive any inferred characteristics in order to ensure that the user profile is an accurate reflection of the current state of the user (location, state of mind, behaviors, demographics, etc. can change rapidly). For example, the user-profile-updater module 124 can be configured to maintain the user profile database 156 to include only data from the last two to three months. However, the user-profile-updater module 124 can be configured to adjust the data in the user profile database 156 to cover any span of time. In some instances the user-profile-updater module 124 can update the profile database 156 in real-time. Alternatively, the user-profile-updater module 124 can be configured to set an expiration period on a subset of the data in the user profile database 156. For example, a policy can specify that user declared data is maintained as long as the user account is active, but user characteristic values based on location information expire after a specified period of time. In some cases, a user can set the expiration period. In some instances, the user-profile-updater module 124 can update the user profile database 156 at least every week, or every day. In some cases, the content delivery system 106 can receive a direct request to update one or more user profiles. The update request can come directly from the user's device or any other device capable of communicating with the content delivery system 106, such as other content delivery networks or websites. In some cases, the content delivery system 106 can receive an indirect request to update one or more user profiles. An indirect request can be the result of receiving new user characteristic values. An update request can occur at any time.

In some embodiments, the content delivery system 106 can include a segment database 158 that is used to aid in selecting invitational content to target to users. The segment database 158 can store defined segments and associations between the segments and users and/or invitational content that should be targeted to users associated with the segments. As described above, a targeted segment can be defined based on one or more user characteristics or derivatives thereof and can be associated with one or more items of invitational content. Additionally, a targeted segment can be associated with one or more users. In some embodiments, by associating a targeted segment with both a user and an item of invitational content, the delivery system can match invitational content with users. In some embodiments, the content delivery system 106 can update the segment database 158 to add newly defined targeted segments or to delete targeted segments.

In some cases a targeted segment can be as simple as a single user characteristic identifier and a single user characteristic value. For example, the common demographic identifiers of gender, age, occupation, or income can each be used in defining corresponding targeted segments. A characteristic value can also be assigned to the identifier. For example, the values of male, 19, and student can be assigned to the user characteristics of gender, age, and occupation, respectively. However, more complex targeted segments can also be defined that consist of one or more identifiers with one or more values associated with each identifier. For example, a targeted segment can be defined to target a user with the following characteristics: gender, male; age, 19-24; location, Northern California or New York City. Additional exemplary segments are described throughout this disclosure. Furthermore, targeted segments can correspond to one or more segments that content providers are likely to easily understand and thus can quickly identify as being relevant to their content. Additionally, in some embodiments, content providers 109 and 110 can define a custom targeted segment.

In some embodiments, the content delivery system 106 can provide a segment assigner module 126. The segment assigner module 126 can apply a set of user characteristics associated with a user (including segments to which a user has been previously assigned) to assign the user to one or more targeted segments. The assigner module 126 can obtain the set of user characteristic values from the user profile database 154 and/or from the user's activities during the current session. The segment assigner module 126 can assign a user to one or more defined targeted segments in the segment database 158, or alternatively, a user can be assigned to a custom targeted segment defined to meet specific goals of a content provider.

Based on the assigned segments, the user profile database 156 can be updated to reflect the segment assignments. Additionally, the content delivery system 106 can use the segment assignments to select targeted content. In some cases, the user profile data in the user profile database 156 can change over time so the segment assigner module 126 can be configured to periodically update the segment assignments in the user profile database 156. The segment assignment update can be triggered at specified intervals, upon detection of a change in the user profile database 156, and/or upon detection of a specified activity in the content delivery system 106.

In some embodiments, the content delivery system 106 can provide a prioritizer module 128. The prioritizer module 128 can perform a variety of prioritizing tasks based on the configuration of the content delivery system 106. In some configurations, the prioritizer module 128 can prioritize the targeted segments assigned to a user. The prioritization can be influenced by a number of factors, which can include the user's context, a content provider's campaign goals, and/or the content that is currently available for display to the user. A request to prioritize the targeted segments can be explicit or implicit and can be made by any component of the system 100. For example, a secondary content provider 110 can explicitly request that the content delivery system 106 prioritize the targeted segments or the request can be implicit as part of a request for a content package. The resulting prioritized list can be provided, for example, to the content management module 122, which can then use the information to assemble and deliver a content package. Additionally, the prioritized list can be stored, for example in the user profile, for later use.

While the content delivery system 106 is presented with specific components, it should be understood by one skilled in the art, that the architectural configuration of system 106 is simply one possible configuration and that other configurations with more or less components are also possible.

As described above, one aspect of the present technology is the gathering and use of data available from various sources to improve the delivery to users of invitational content or any other content that may be of interest to them. The present disclosure contemplates that in some instances, this gathered data may include personal information data that uniquely identifies or can be used to contact or locate a specific person. Such personal information data can include demographic data, location-based data, telephone numbers, email addresses, twitter ID's, home addresses, or any other identifying information.

The present disclosure recognizes that the use of such personal information data, in the present technology, can be used to the benefit of users. For example, the personal information data can be used to deliver targeted content that is of greater interest to the user. Accordingly, use of such personal information data enables calculated control of the delivered content. Further, other uses for personal information data that benefit the user are also contemplated by the present disclosure.

The present disclosure further contemplates that the entities responsible for the collection, analysis, disclosure, transfer, storage, or other use of such personal information data will comply with well-established privacy policies and/or privacy practices. In particular, such entities should implement and consistently use privacy policies and practices that are generally recognized as meeting or exceeding industry or governmental requirements for maintaining personal information data private and secure. For example, personal information from users should be collected for legitimate and reasonable uses of the entity and not shared or sold outside of those legitimate uses. Further, such collection should occur only after receiving the informed consent of the users. Additionally, such entities would take any needed steps for safeguarding and securing access to such personal information data and ensuring that others with access to the personal information data adhere to their privacy policies and procedures. Further, such entities can subject themselves to evaluation by third parties to certify their adherence to widely accepted privacy policies and practices.

Despite the foregoing, the present disclosure also contemplates embodiments in which users selectively block the use of, or access to, personal information data. That is, the present disclosure contemplates that hardware and/or software elements can be provided to prevent or block access to such personal information data. For example, in the case of advertisement delivery services, the present technology can be configured to allow users to select to “opt in” or “opt out” of participation in the collection of personal information data during registration for services. In another example, users can select not to provide location information for targeted content delivery services. In yet another example, users can select to not provide precise location information, but permit the transfer of location zone information.

Therefore, although the present disclosure broadly covers use of personal information data to implement one or more various disclosed embodiments, the present disclosure also contemplates that the various embodiments can also be implemented without the need for accessing such personal information data. That is, the various embodiments of the present technology are not rendered inoperable due to the lack of all or a portion of such personal information data. For example, content can be selected and delivered to users by inferring preferences based on non-personal information data or a bare minimum amount of personal information, such as the content being requested by the device associated with a user, other non-personal information available to the content delivery services, or publically available information.

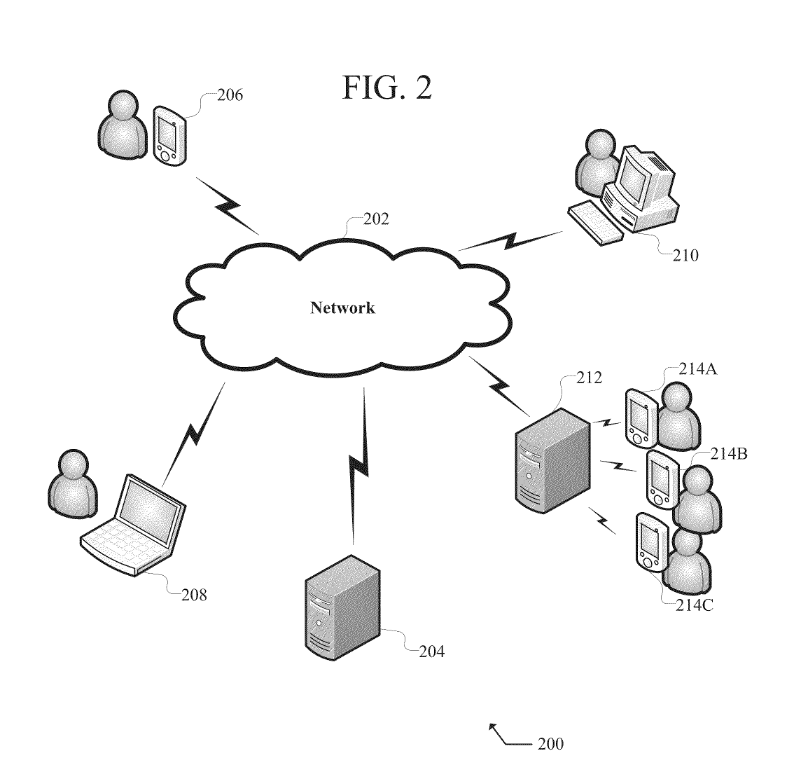

The disclosure now turns to a discussion of content bartering, followed by a discussion of an exemplary content bartering system 200, illustrated in FIG. 2. Content bartering can be used to barter ad impressions for application developers. App publishers of all sizes and categories can barter among each other for ad impressions for their respective applications. This way, developers can advertise their applications through other applications. App developers can advertise any content, including applications, standalone content items, and even “freemium” content within applications that other developers and/or publishers own. Value ad impressions within different applications can be used to help developers when bartering with each other. Applications can be valued relative to each other, for example, to ensure a fair balance of value given and received between bartering parties. An ad network can be used to manage bartering transactions to ensure that the bartering occurs seamlessly and that every advertiser and/or developer meets her commitments.

Applications can be added to a barter network that contains various applications for bartering. Applications in the barter network can be assigned to an application category based on a characteristic of the application, such as a type (e.g., game, business, educational, etc.), a subject, a developer, a date, a popularity, a rating, a profit, a timestamp, etc. The applications in the barter network can also be assigned an intrinsic value. The intrinsic value can be used to barter content associated with the applications, such as ad impressions, for example. The intrinsic value can be based on the value of impressions available in the respective application. In some cases, a higher value can be assigned based on, for example, a lower number of impressions per unique user; a reach; a popularity associated with the application; a rating associated with the application; particularly desirable demographic characteristics, such as specific age groups or income brackets which are known to produce higher rates of application downloads for that application category; etc. In other cases, application inventory can also have a higher intrinsic value if it includes particular rare categories, which another application may wish to use to target content. Application inventory can also be valued by other factors, such as the historical tendency of users who have downloaded other applications through that application to engage in ‘freemium’ purchases within the new application. A total lifetime user spend value can be computed for this purpose. Similarly, the value of advertising inventory generated by the application downloaded can be added to the total lifetime value. The total lifetime value can be tracked voluntarily by participating applications, for example, through the use of a unique identifier assigned to each application download. The unique identifier can be assigned by a content application or an online store, such as iTunes® or iAd® by Apple Inc. of Cupertino, Calif., to keep track of freemium purchases and advertising revenue generated by the referred user. If an application has not yet issued a sufficient number of requests to the barter network in order to produce a valid breakdown of the inventory contents, it can be initially given a default value based on its application category, for example.

Trading of application inventory can occur based on various factors and trading approaches. For example, trading can be based on intrinsic valuation, download-for-download, a hybrid approach, etc. In the intrinsic valuation approach, each application can be given an intrinsic value score, as previously mentioned. The score of each of the applications to be bartered can then be compared to determine a ratio, and an exchange rate for impressions between the applications can be set based on that ratio. For example, if App A has a value of 2 and App B has a value of 4, then App A can be configured to receive one impression from App B for every two impressions it provides. The intrinsic value can be updated for each application on a regular basis based on past performance (e.g., once a day), current circumstances, current performance, application updates/changes, updated characteristics associated with an application, etc. Moreover, the exchange rate can also be updated accordingly. If two or more applications have traded directly with each other previously, then the overall intrinsic value can be overridden by an estimate of the intrinsic value specifically to the relationship of those applications, including freemium purchases or advertising dollars which have accrued. In some cases, intrinsic value can be determined for every request generated based on a combination of the demographic or other targeting parameters, and/or the total lifetime value of the user. As illustrated above, intrinsic value can be calculated specifically for an application attempting to barter for an impression, if sufficient data is available.

In the download-for-download approach, each application can be required to provide an equal number of downloads or impressions to each other. Since the downloads or impressions typically do not occur simultaneously, a buffer amount can be set, such as 5, 50, 100, etc. In some cases, any downloads or impressions can be stopped when an application exceeds the buffer amount. For example, when App A has achieved a number of conversions for App B that meets or exceeds the buffer amount, serving of impressions for App B within App A can be temporarily halted until App B makes up the deficit in downloads for App A.

In the hybrid approach, the download-for-download approach can be used with a multiplicative modifier, which can be applied to the value of each download, based on intrinsic valuation parameters, such as demographics and total lifetime value.

With content bartering, trading partners can be discovered in a number of ways to increase the number of possible trading partners and possibly expand the number of exchanges. In some cases, potential trading partners can be discovered through the use of ‘App Banks’ which can include applications that have similar profiles to each other. Applications can be grouped into banks based on one or more factors, such as the specific function of the application, similarity of user characteristics, etc. In some instances, such as arcade games, application developers may wish to trade impressions with others within their specific application bank, but in others, such as airline reservation applications, application developers may not wish to barter with members of their application bank because users are more likely to switch entirely to the competitor and stop using the original application. Thus, bartering with fellow application bank members can be enabled or disabled by application developers as desired. Additionally, application developers can blacklist specific known competitors whose applications they would prefer not to advertise for. Applications can also trade with neighboring application banks preferentially. For example, airline reservation applications may trade with hotel or taxi-related applications. Which application banks neighbor each other can be determined by a ‘market basket’ analysis of what application groupings tend to be downloaded together, which can be further refined by the actual download rate performance achieved from one application bank to another by the bartering system.

Bartering transactions can include one-to-one transactions, but can also include multi-party transactions. In some cases, multi-party transactions can be asymmetric. For example, in some instances, App A's impressions may perform well for App B, but App B's impressions may not perform well for App A. In this case, an additional partner, App C, may be found which performs well for App A, and which App B does perform well for. Here, the desired relationship can be that App A serve ads for App B, App B serve ads for App C, and App C serve ads for App A. The bartering system can search and find such potentially desirable multi-party relationships (which can include more than three applications). In some cases, the bartering system can search these relationships through a graph analysis. Such asymmetric relationships can be managed with the ad network delegating which apps to send the impressions to, for each other application, so as to maximize conversions while maintaining a balance of credit for the amount of intrinsic value, download-for-download value, or hybrid value delivered to and from each application, using the buffer methodology described above.

As described above, in some embodiments, the content offered in bartered exchanges can be of the same type. However, in other embodiments, trading partners can trade different types of inventory. For example, a trading partner can trade a banner with an interstitial. Thus, the traded objects can differ from one another, which can depend on a trading partner's specific objections. For example, a ‘Full Screen Banner’ may command a higher user attention and real-estate premium than conventional ‘Standard Banners’ or partial page banners. A ‘Pre-Roll’ video advertisement similarly may command a higher premium than full-screen or standard banners. To this end, the publisher that has opted into the barter network can elect to forgo paid advertisements coming in from conventional ad networks, to allow for barter advertisements to run in such premium advertisement positions. Depending on the amount of credit and exposure the publisher wants to make, premium advertisements can be offered for a higher conversion value. Depending on the efficacy of the barter network exposure, this can imply that a publisher may elect to use all of the premium advertisement inventory available at their disposal to either generate additional credit or clear out an outstanding deficit for the barter network. Trading can also take into account non-standard advertising methods, such as sponsored listings in content feeds, referral codes, sponsored content placement and more.

Furthermore, obfuscated and/or un-obfuscated user preference data can also be used for trading. User usage and preference data can be a powerful tool that a publisher can bring to the barter network. A publisher (depending on their terms of service with end users) can elect to offer anonymized user preference data along with request for advertisement placements. Thus, user's affinity to certain applications or content can be analyzed and incorporated, which can lead to a higher conversion for other barter publishers. In return, the publisher offering this data can require a higher conversion value for its own advertisements on the network. This can be similar to the OpenID initiative, by the OpenID Foundation, though, in some cases, in a more complex manner, as publisher user data can be used in many different ways. A publisher bank can value the publisher preference data more than a nonrelated bank. Though there can be other contextual data that may be valued by applications in non-related banks.

The disclosure now turns to FIG. 2, which illustrates an exemplary architecture 200 for bartering content. The architecture 200 includes a bartering server 204 for managing an exchange and/or bartering of content between applications. The bartering server 204 communicates with bartering devices 206-212 to initiate, establish, manage, complete, modify, and/or process a bartering exchange of content. The bartering devices 206-212 can be any devices with networking capabilities. Moreover, the bartering devices 206-212 can be associated with respective applications and/or developers associated with a bartering of content. In some cases, bartering device 212 can also be a server associated with a group of other bartering devices 214A-C. The other bartering devices 214A-C can be associated with a group of respective applications and/or developers. The bartering device 212 can thus manage communications with the bartering server 204, on behalf of the other bartering devices 214A-C.

The bartering devices 206-212 can communicate with the bartering server 204 via network 202. The network 202 can include a public network, such as the Internet, but can also include a private or quasi-private network, such as an intranet, a home network, a virtual private network (VPN), a shared collaboration network between separate entities, etc. Indeed, the principles set forth herein can be applied to many types of networks, such as local area networks (LANs), virtual LANs (VLANs), corporate networks, wide area networks, and virtually any other form of network. As previously mentioned, each of the bartering devices 206-212 can communicate with the bartering server 204, via network 202, as part of a bartering transaction. In some cases, any of the bartering devices 206-212 can be a server for providing content associated with respective applications. Here, the bartering devices 206-212 can also provide bartered content associated with other applications, as part of a bartering transaction processed by the bartering server 204. For example, bartering device 206 can be a server for providing content associated with a respective application of bartering device 206. However, in addition, bartering device 206 can also provide bartered content from one or more of the devices 208-212 and/or 214A-C, as part of a bartering transaction.

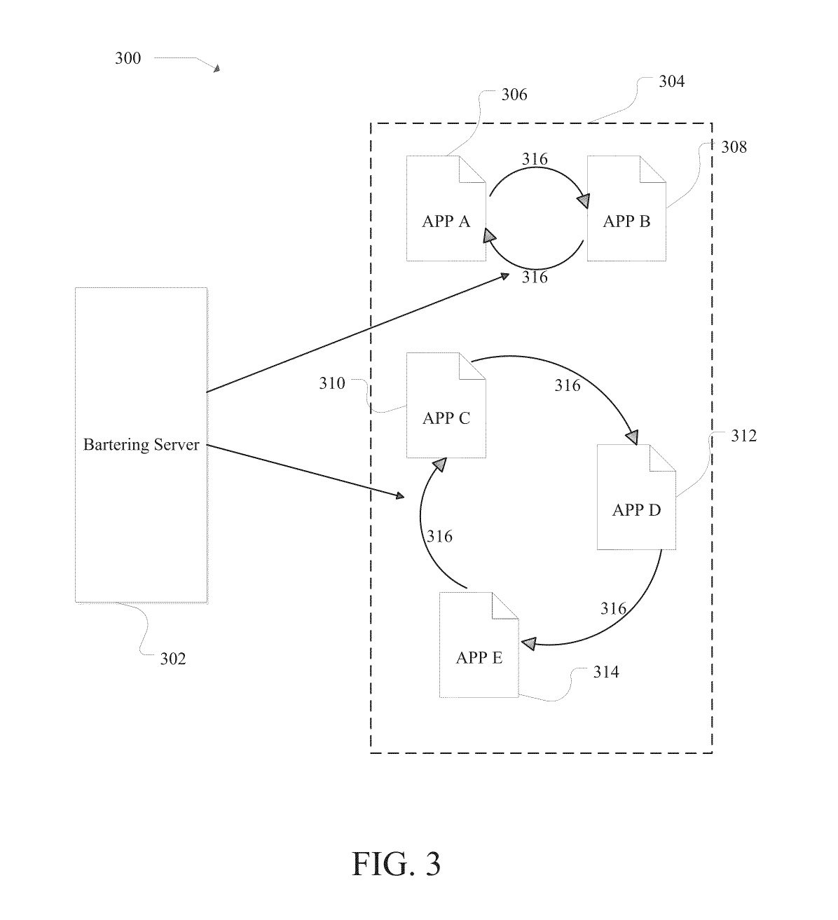

FIG. 3 illustrates an exemplary content bartering system 300. The bartering system 300 can include a bartering server 302, which can be any device configured to manage an exchange and/or bartering of content between applications. In some cases, the bartering server 302 can be a content delivery system 106, as illustrated in FIG. 1. The bartering system 300 can include a bartering network 304, which can include applications 306-314 for bartering content. The applications 306-314 can be grouped into one or more groups within the bartering network 304. Moreover, the applications 306-314 can be grouped based on one or more factors, such as application characteristics, application function, profits, application value, application popularity, application type, application rating, application developer, an associated company, an associated owner, etc. In some cases, the bartering network 304 can include multiple groups of applications. For example, the bartering network 304 can include application banks (not shown), which can include groups of applications. An application bank can include applications with similar attributes, characteristics, preferences, settings, profiles, functions, user characteristics, performance, timestamps, developers, etc.

As previously mentioned, the bartering server 302 can manage bartering and/or exchanges of content between the applications 306-314. For example, the bartering server 302 can manage an exchange 316 between applications 306 and 308. The exchange 316 can be a symmetric exchange, where the application 306 can serve content associated with application 308, and application 308 can serve content associated with application 306. The bartered content can include advertisements, application objects, advertising impressions, software, web pages, media content, etc. Moreover, the exchange 316 can be according to an exchange rate determined by the bartering server 302. For example, in some embodiments, the exchange 316 can be a download-for-download or item-for-item exchange between the applications 306 and 308. In other embodiments, the exchange 316 can be based on any other ratio, such as a 2-1 ratio, a 3-1 ratio, or an n-m ratio. The applications 306 and 308 can be identified and/or selected for the exchange 316 based on one or more factors, such as respective values, respective categories of content, respective types of applications, respective ratings, respective settings, respective characteristics, respective performances, respective types of bartered content, prior transactions, etc. Additional characteristics, approaches, and details regarding an exchange of content are further described above in the discussion of content bartering.

The bartering server 302 can also manage an exchange 318 between applications 310-314. The exchange 318 can be a multi-party, asymmetric exchange between the applications 310-314. For example, according to the exchange 318, application 312 can serve content for application 310, application 314 can serve content for application 312, and application 310 can serve content for application 314. The exchange 318 can be based on an exchange rate, as determined by the exchange server 302. For example, the exchange rate can be 1-2-1, where application 312 serves one advertisement for application 310, application 314 can serve two advertisements for application 312, and application 310 can serve one advertisement for application 314. This way, the number of advertisements served by any of the applications 310-314 can depend on the number of advertisements served by any other of the applications 310-314. The exchange rate can be based on one or more factors, as previously described above.

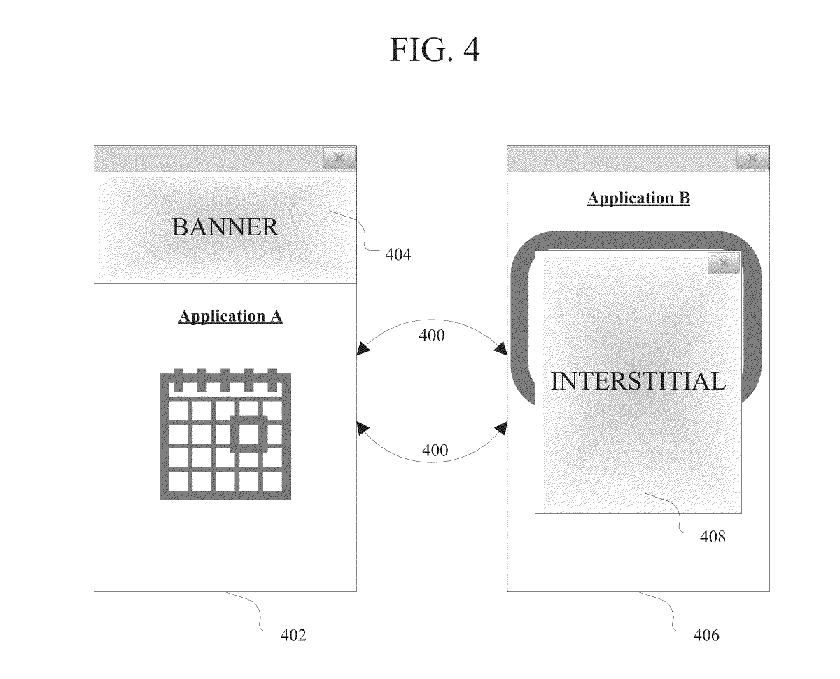

FIG. 4 illustrates an exemplary bartering exchange 400 of objects 404 and 408. The bartering exchange 400 can be between App A 402 and App B 406. However, in other embodiments, the exchange can be between App A 402 and App B 406, and one or more additional applications. App A 402 and App B 406 can each be associated with a respective developer and/or owner. This way, each developer can exchange respective objects with the other developer.

In some cases, the objects 404 and 408 can be impressions, such as advertising impressions. Moreover, the objects 404 and 408 can include any type of content, such as media content, advertisements, software, web pages, etc. In FIG. 4, object 404 is a display banner and object 408 is an interstitial. However, these examples are provided for illustration purposes and, as one of ordinary skill in the art will readily understand, the objects 404 and 408 can vary and/or include any other type of content, as previously described. Further, while FIG. 4 illustrates two objects, other embodiments can include additional objects. For example, the exchange 400 can include more than two objects, which can be associated with two or more owners and/or developers. In some cases, the exchange 400 can be an exchange of two objects associated with a specific developer and/or owner with one or more objects associated with another developer and/or owner. For example, the exchange 400 can be an exchange of two different types of objects of a specific developer, with one object of a different developer, multiple objects of the different developer, or multiple objects of multiple other developers.

As part of the exchange 400, App A 402 can serve object 404, which is associated with App B 406, and App B 406 can serve object 408, which is associated with App A 402. This way, App A 402 can have App B 406 serve App A's 402 banner, and App B 406 can have App A 402 serve App B's 406 interstitial. The exchange 400 of objects 404 and 408 can be based on an exchange rate, as described above. For example, the exchange 400 of objects 404 and 408 can be a download-for-download exchange.

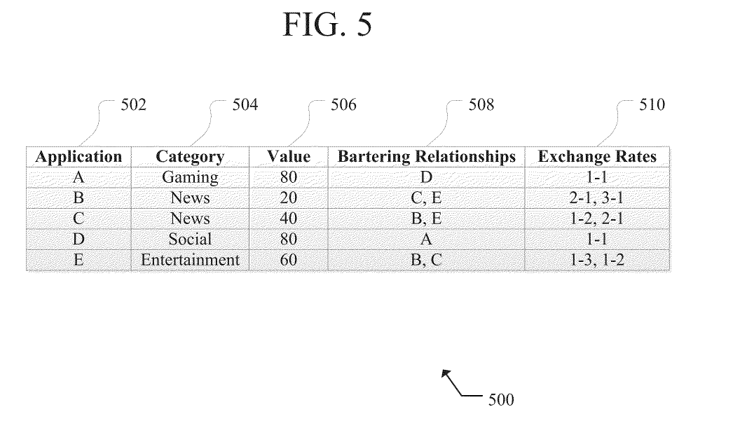

FIG. 5 illustrates an exemplary bartering table 500 for bartering advertising impressions. The bartering table 500 can be used by a bartering server, such as bartering server 302 illustrated in FIG. 3, to conduct and/or manage bartering transactions. The bartering table 500 can include applications 502 from a bartering network, such as bartering network 304 illustrated in FIG. 3. The applications 502 can include applications associated with one or more bartering transactions. In FIG. 5, the applications 502 include applications A-E. Each of the applications A-E can be associated with a specific developer and/or owner. Moreover, the applications 502 can by associated with categories 504, based on one or more application characteristics, such as application type. For example, application A can be associated with a gaming category based on a determination that application A is a gaming application. Further, applications B and C can be associated with a news category, application D can be associated with a social category, and application E can be associated with an entertainment category.

The bartering table 500 can include values 506 for the applications 502. For example, applications A and D can have a value of 80, application B can have a value of 20, application C can have a value of 40, and application E can have a value of 60. The values 506 can be, for example, intrinsic values, scores, ratings, performance, cost, etc. The values 506 can be calculated as previously described in the discussion of bartering content. Moreover, the values 506 can be general values associated with the applications 502, and/or specific values that are defined for specific bartering relationships or exchanges. The bartering table 500 can also include bartering relationships 508 associated with the applications 502. The bartering relationships 508 can be based on bartering transactions associated with the applications 502. For example, application A has a bartering relationship with application D and vice versa. Application B has a bartering relationship with application C and vice versa. Finally, application E has a bartering relationship with applications B and C, and vice versa. The bartering relationships 508 can indicate that specific applications were involved in bartering transactions with each other. This can mean that the applications exchanged content with each other, for example, but can also mean that they were involved in asymmetric transactions involving the various applications defined in the specific bartering relationship.

Furthermore, the bartering table 500 can include exchange rates 510, which can indicate the exchange ratios defined for the bartering relationships 508. Thus, the exchange rates 510 can depend on the bartering relationships 508. For example, application A has a bartering relationship with application D, which is defined by a 1-1 exchange rate. This indicates that applications A and D exchanged content on a download-for-download basis.

The information in the bartering table 500 of FIG. 5 is presented for illustration purposes, and can include more or less information. For example, the bartering table 500 can also include other columns of information, such as groups, developers, owners, scores, additional values, object types, performance, status, history, exclusions, relationship requests, etc.

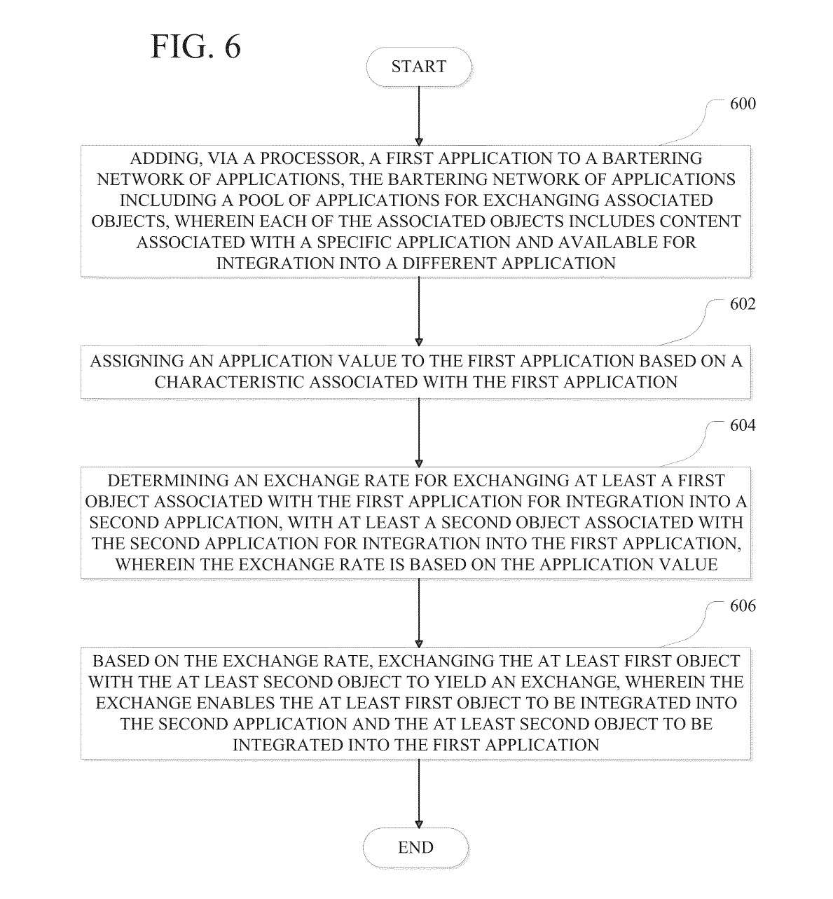

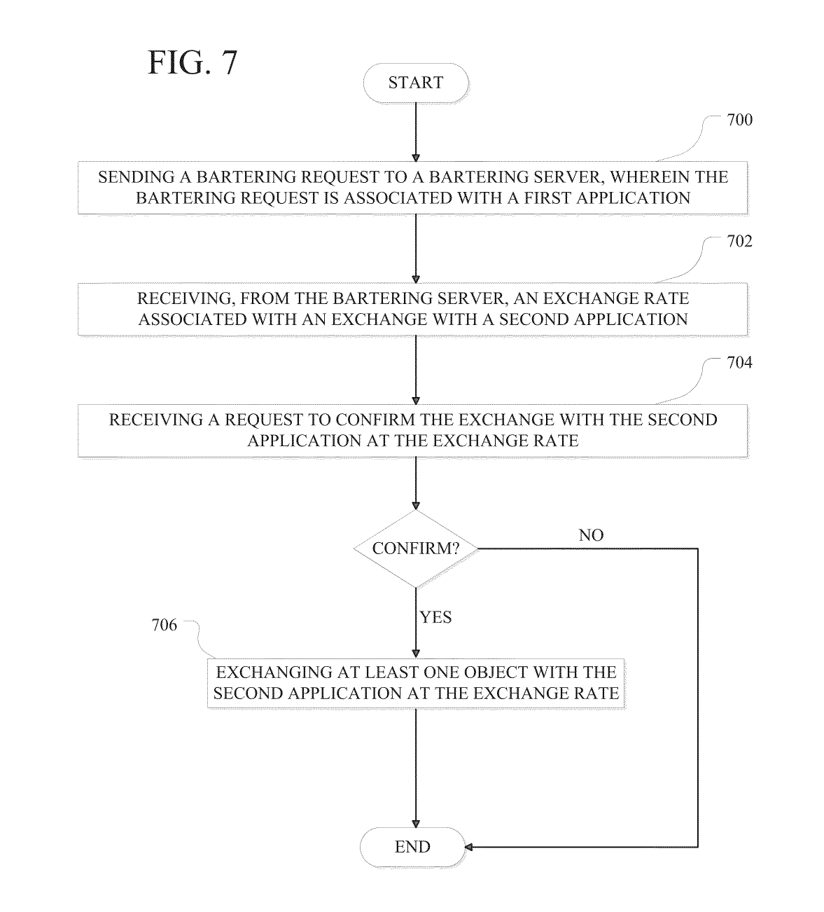

Having disclosed some basic system components and concepts, the disclosure now turns to the exemplary method embodiments and flowcharts shown in FIGS. 6 and 7. For the sake of clarity, the method in FIG. 6 is described in terms of a content delivery system 106, as shown in FIG. 1, configured to practice the method. Moreover, the flowchart in FIG. 7 is described in terms of user terminal 102ᵢ, as shown in FIG. 1, configured to practice the steps. The steps outlined herein are exemplary and can be implemented in any combination thereof, including combinations that exclude, add, or modify certain steps.

FIG. 6 illustrates an exemplary method embodiment. The content delivery system 106 first adds a first application to a bartering network of applications, the bartering network of applications including a pool of applications for exchanging associated objects, wherein each of the associated objects includes content associated with a specific application and available for integration into a different application (600). The first application can be assigned to a category within the bartering network of applications. The category can be based on one or more factors, such as a type of application, a score, a rating, a popularity, a request, a characteristic, a date, a version, a user characteristic, etc. The bartering network can include application banks, which can include groups of applications for bartering. The first application can be added to the bartering network in response to a request from a user associated with the first application, such as a developer or an owner. The first application can also be automatically added to the bartering network based on a search of applications having a specific trait and/or characteristic of the first application. Moreover, the first application can also be added to the bartering network based on a subscription, a profile, a relationship with a developer and/or an application, a recommendation, a service, etc. The associated objects can refer to content, impressions, user actions (e.g., conversions), and/or responses to content.

Next, the content delivery system 106 assigns an application value to the first application based on a characteristic associated with the first application (602). The application value can be, for example, an intrinsic value, a score, an objective value, an estimated performance, a revenue, etc. An intrinsic value can be based on a value of impressions, a number of impressions, a performance, a cost, a conversion rate, a demographic, an application type, etc. As previously mentioned, the bartering value can be based on a characteristic. Here, the characteristic can include one or more factors, such as a number of impressions per unique user, a reach associated with the first application, a demographic characteristic associated with the first application, an application category, a historical tendency of users who have downloaded a separate application through the first application to purchase content associated with the separate application, a targeting parameter, and a total lifetime user spend value associated with the first application, and so forth.

The content delivery system 106 then determines an exchange rate for exchanging at least a first object associated with the first application for integration into a second application, with at least a second object associated with the second application for integration into the first application, wherein the exchange rate is based on the application value (604). In some embodiments, the exchange rate is for exchanging one or more objects associated with the first application with one or more objects associated with the second application, where the objects of the first application are to be served at the second application, and the objects of the second application are to be served at the first application. As previously described, the objects can refer to content, impressions, user actions (e.g., conversions), and/or responses to content.

The exchange rate can be based on the bartering value and/or one or more factors, such as an application category, an application rating, an application score, a bartering history, a conversion rate, a cost, a performance, etc. The exchange rate can also be based on a bartering value of the second application and/or one or more factors, as illustrated above, associated with the second application. In some embodiments, the content delivery system 106 can compare application values associated with the first application and the second application to determine the exchange rate. The content delivery system 106 can also compare any of the one or more factors described above, in order to determine the exchange rate. The content delivery system 106 can also compare values associated with the objects to be exchanged. For example, if the object associated with the first application is associated with a higher value than the object associated with the second application, then the exchange rate can reflect this difference in values. To this end, the objects exchanged can be of a same type, but can otherwise be of different types. Moreover, the exchange rate can be based on an intrinsic valuation approach, a one-for-one approach, and/or a hybrid approach, for example.

The exchange rate can be based on a general valuation of the first application and/or the second application. However, the exchange rate can also be based on a specific valuation of the first application relative to the second application. Moreover, the exchange rate can be updated based on performance. Thus, the exchange rate can be dynamic.

Based on the exchange rate, the content delivery system 106 can exchange the at least first object with the at least second object to yield an exchange, wherein the exchange enables the at least first object to be integrated into the second application and the at least second object to be integrated into the first application. An object can be integrated into an application by incorporating the object into the application, displaying the object with the application, serving the object with the application, associating the object with the application, etc. In some embodiments, the exchange can be for displaying one or more objects of the first application at the second application, and displaying one or more objects of the second application at the first application. In other embodiments, the exchange is a multi-party exchange between the first application, the second application, and one or more applications. Here, the exchange can be for one or more objects associated with each of the first, second, and additional applications. Moreover, the exchange can be based on an exchange rate determined for the exchange between the first, second, and additional applications. Further, the exchange between the first, second, and additional applications can be a symmetric exchange or an asymmetric exchange, as further detailed above.

In some embodiments, prior to the exchange, the content delivery system 106 can search for one or more applications to barter with the first application. For example, the content delivery system 106 can search the bartering network of applications for application(s) that are possible candidates for bartering with the first application. The content delivery system 106 can search for candidates based on respective application values, such as intrinsic values, as well as any other factors, such as trading relationships, trading requests, trading intents, performance, cost, application categories, application types, application ratings, application developers, etc. For example, the content delivery system 106 can search for the second application based on the bartering value of the first application, determine the exchange rate, and manage the exchange between the first application and the second application.

Similarly, the content delivery system 106 can search and/or identify trading partners for bartering with the first application. The trading partners can be identified via an application bank that contains groups of applications. The applications in the groups can be grouped based on application profiles, functions, characteristics, and so forth. In searching for trading partners, the content delivery system 106 can also look at relationships in the application banks, historical information, statistics, exclusion lists, preferences, etc.

FIG. 7 illustrates an exemplary flowchart for bartering content. User terminal 102ᵢ first sends a bartering request to a bartering server, wherein the bartering request is associated with a first application (700). The bartering request can be a request to barter one or more objects of the first application with other applications. The bartering request can include information and data associated with the first application, such as performance statistics, an application description, developer information, ratings, object description, objective, exclusions, preferences, demographics, financial information, etc. The bartering request can also specify one or more objects or applications that it wants to barter with/for.

User terminal 102ᵢ then receives, from the bartering server, an exchange rate associated with an exchange with a second application (702). The exchange rate can be based on an intrinsic value of the first application and/or the second application. Moreover, the exchange can be for exchanging one or more objects between the first application and the second application. In particular, the exchange can be for integrating one or more objects of the first application into the second application, and integrating one or more objects of the second application into the first application.

User terminal 102ᵢ also receives a request to confirm the exchange with the second application at the exchange rate (704). In some embodiments, however, the exchange is established automatically and/or without any confirmation from the user terminal 102ᵢ. In other embodiments, User terminal 102ᵢ can agree to commit to the exchange prior to the bartering server finding the application to barter with the first application (i.e., the second application and any additional applications), prior to the bartering server determining the exchange rate, and/or at any point beforehand. In some cases, the user terminal 102ᵢ blindly commit to the exchange based on a blind bartering advertisement, such as an advertisement presenting a general characteristic(s) of the application(s) and/or object(s) to barter with but without information regarding the specific identity of the application(s) and/or object(s).

If user terminal 102ᵢ confirms the exchange, then user terminal 102ᵢ exchanges at least one object with the second application at the exchange rate (706). On the other hand, if user terminal 102ᵢ does not confirm the exchange, then the exchange is terminated. If user terminal 102ᵢ does not confirm the exchange, user terminal 102ᵢ can otherwise counter with another offer and/or exchange. Similarly, the bartering server can also counter with another exchange rate and/or exchange.

As part of exchanging the at least one object, user terminal 102ᵢ can integrate exchanged objects of the second application into the first application. For example, user terminal 102ᵢ can serve the exchanged objects of the second application within the first application. In some cases, user terminal 102ᵢ can receive the object(s) to be integrated into the first application from the bartering server. In other cases, user terminal 102ᵢ can receive the object(s) directly from a device associated with the second application. For example, user terminal 102ᵢ can receive the object(s) directly from the developer of the object(s) and/or the second application.

After integrating the exchanged object(s) into the first application, user terminal 102ᵢ and/or the bartering server can keep track of a performance and/or statistics associated with the exchanged object(s) and/or the first application. Performance and/or statistics information can then be used to update the exchange and/or the exchange rate, for example.

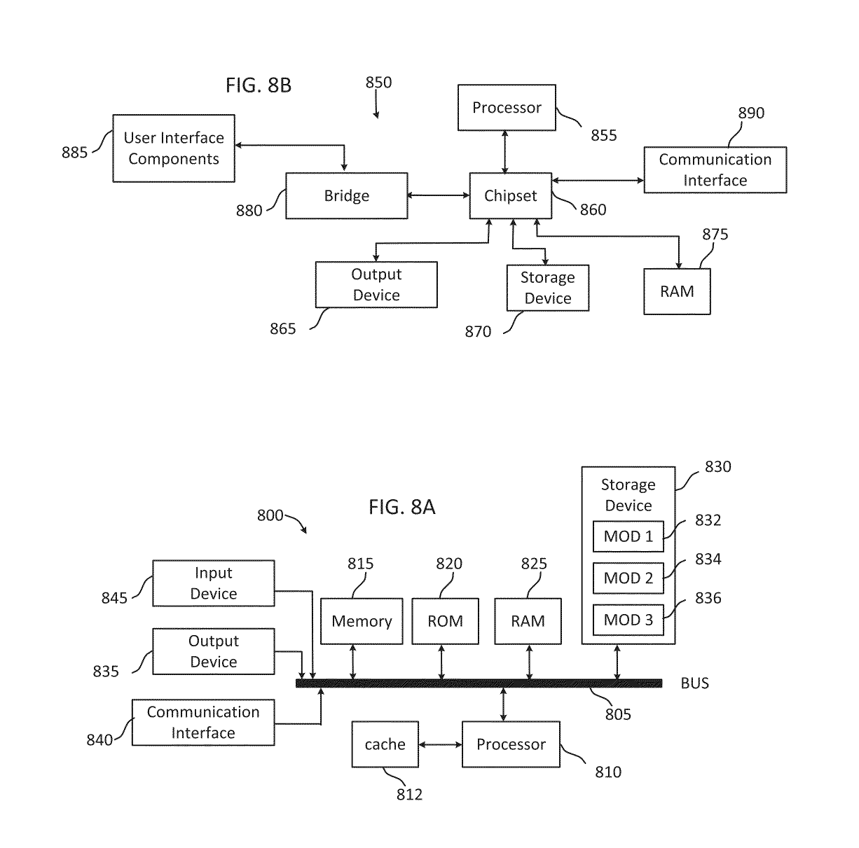

The disclosure now turns to FIGS. 8A and 8B, which illustrate exemplary possible system embodiments. The more appropriate embodiment will be apparent to those of ordinary skill in the art when practicing the present technology. Persons of ordinary skill in the art will also readily appreciate that other system embodiments are possible.

FIG. 8A illustrates a conventional system bus computing system architecture 800 wherein the components of the system are in electrical communication with each other using a bus 805. Exemplary system 800 includes a processing unit (CPU or processor) 810 and a system bus 805 that couples various system components including the system memory 815, such as read only memory (ROM) 820 and random access memory (RAM) 825, to the processor 810. The system 800 can include a cache of high-speed memory connected directly with, in close proximity to, or integrated as part of the processor 810. The system 800 can copy data from the memory 815 and/or the storage device 830 to the cache 812 for quick access by the processor 810. In this way, the cache can provide a performance boost that avoids processor 810 delays while waiting for data. These and other modules can control or be configured to control the processor 810 to perform various actions. Other system memory 815 may be available for use as well. The memory 815 can include multiple different types of memory with different performance characteristics. The processor 810 can include any general purpose processor and a hardware module or software module, such as module 1 832, module 2 834, and module 3 836 stored in storage device 830, configured to control the processor 810 as well as a special-purpose processor where software instructions are incorporated into the actual processor design. The processor 810 may essentially be a completely self-contained computing system, containing multiple cores or processors, a bus, memory controller, cache, etc. A multi-core processor may be symmetric or asymmetric.

To enable user interaction with the computing device 800, an input device 845 can represent any number of input mechanisms, such as a microphone for speech, a touch-sensitive screen for gesture or graphical input, keyboard, mouse, motion input, speech and so forth. An output device 835 can also be one or more of a number of output mechanisms known to those of skill in the art. In some instances, multimodal systems can enable a user to provide multiple types of input to communicate with the computing device 800. The communications interface 840 can generally govern and manage the user input and system output. There is no restriction on operating on any particular hardware arrangement and therefore the basic features here may easily be substituted for improved hardware or firmware arrangements as they are developed.

Storage device 830 is a non-volatile memory and can be a hard disk or other types of computer readable media which can store data that are accessible by a computer, such as magnetic cassettes, flash memory cards, solid state memory devices, digital versatile disks, cartridges, random access memories (RAMs) 825, read only memory (ROM) 820, and hybrids thereof.

The storage device 830 can include software modules 832, 834, 836 for controlling the processor 810. Other hardware or software modules are contemplated. The storage device 830 can be connected to the system bus 805. In one aspect, a hardware module that performs a particular function can include the software component stored in a computer-readable medium in connection with the necessary hardware components, such as the processor 810, bus 805, display 835, and so forth, to carry out the function.

FIG. 8B illustrates a computer system 850 having a chipset architecture that can be used in executing the described method and generating and displaying a graphical user interface (GUI). Computer system 850 is an example of computer hardware, software, and firmware that can be used to implement the disclosed technology. System 850 can include a processor 855, representative of any number of physically and/or logically distinct resources capable of executing software, firmware, and hardware configured to perform identified computations. Processor 855 can communicate with a chipset 860 that can control input to and output from processor 855. In this example, chipset 860 outputs information to output 865, such as a display, and can read and write information to storage device 870, which can include magnetic media, and solid state media, for example. Chipset 860 can also read data from and write data to RAM 875. A bridge 880 for interfacing with a variety of user interface components 885 can be provided for interfacing with chipset 860. Such user interface components 885 can include a keyboard, a microphone, touch detection and processing circuitry, a pointing device, such as a mouse, and so on. In general, inputs to system 850 can come from any of a variety of sources, machine generated and/or human generated.

Chipset 860 can also interface with one or more communication interfaces 890 that can have different physical interfaces. Such communication interfaces can include interfaces for wired and wireless local area networks, for broadband wireless networks, as well as personal area networks. Some applications of the methods for generating, displaying, and using the GUI disclosed herein can include receiving ordered datasets over the physical interface or be generated by the machine itself by processor 855 analyzing data stored in storage 870 or 875. Further, the machine can receive inputs from a user via user interface components 885 and execute appropriate functions, such as browsing functions by interpreting these inputs using processor 855.

It can be appreciated that exemplary systems 800 and 850 can have more than one processor 810 or be part of a group or cluster of computing devices networked together to provide greater processing capability.

For clarity of explanation, in some instances the present technology may be presented as including individual functional blocks including functional blocks comprising devices, device components, steps or routines in a method embodied in software, or combinations of hardware and software.

In some embodiments the computer-readable storage devices, mediums, and memories can include a cable or wireless signal containing a bit stream and the like. However, when mentioned, non-transitory computer-readable storage media expressly exclude media such as energy, carrier signals, electromagnetic waves, and signals per se.

Methods according to the above-described examples can be implemented using computer-executable instructions that are stored or otherwise available from computer readable media. Such instructions can comprise, for example, instructions and data which cause or otherwise configure a general purpose computer, special purpose computer, or special purpose processing device to perform a certain function or group of functions. Portions of computer resources used can be accessible over a network. The computer executable instructions may be, for example, binaries, intermediate format instructions such as assembly language, firmware, or source code. Examples of computer-readable media that may be used to store instructions, information used, and/or information created during methods according to described examples include magnetic or optical disks, flash memory, USB devices provided with non-volatile memory, networked storage devices, and so on.

Devices implementing methods according to these disclosures can comprise hardware, firmware and/or software, and can take any of a variety of form factors. Typical examples of such form factors include laptops, smart phones, small form factor personal computers, personal digital assistants, and so on. Functionality described herein also can be embodied in peripherals or add-in cards. Such functionality can also be implemented on a circuit board among different chips or different processes executing in a single device, by way of further example.

The instructions, media for conveying such instructions, computing resources for executing them, and other structures for supporting such computing resources are means for providing the functions described in these disclosures.

Although a variety of examples and other information was used to explain aspects within the scope of the appended claims, no limitation of the claims should be implied based on particular features or arrangements in such examples, as one of ordinary skill would be able to use these examples to derive a wide variety of implementations. Further and although some subject matter may have been described in language specific to examples of structural features and/or method steps, it is to be understood that the subject matter defined in the appended claims is not necessarily limited to these described features or acts. For example, such functionality can be distributed differently or performed in components other than those identified herein. Rather, the described features and steps are disclosed as examples of components of systems and methods within the scope of the appended claims. Claim language reciting “at least one of” a set indicates that one member of the set or multiple members of the set satisfy the claim. Tangible computer-readable storage media, computer-readable storage devices, or computer-readable memory devices, expressly exclude media such as transitory waves, energy, carrier signals, electromagnetic waves, and signals per se.

We claim:

1. A method comprising:
adding, via a processor, a first application to a bartering network of applications, the bartering network of applications comprising a pool of applications for exchanging associated objects, wherein each of the associated objects comprises content associated with a specific application and available for integration into a different application;
assigning an application value to the first application based on at least one characteristic associated with the first application;
determining an exchange rate for exchanging at least a first object associated with the first application with at least a second object associated with the second application, wherein the exchange rate is based on the application value; and
based on the exchange rate, exchanging the at least first object with the at least second object to yield an exchange, wherein the exchange causes the at least first object to be integrated into the second application and the at least second object to be integrated into the first application.

2. The method of claim 1, further comprising sending the at least first object to the second application for integration into the second application, and sending the at least second object to the first application for integration into the first application.

3. The method of claim 2, wherein the at least first object is sent to the second application for display at the second application, and wherein the at least second object is sent to the first application for display by the first application.

4. The method of claim 1, wherein each of the associated objects comprises content associated with the specific application and available for display by the different application, wherein the exchange rate is for exchanging at least the first object for display at the second application with at least the second object for display at the second application, and wherein the exchange enables the at least first object to be displayed at the second application and the at least second object to be displayed at the first application.

5. The method of claim 1, wherein adding the first application to the bartering network of applications further comprises assigning an application category to the first application based on a type of application associated with the first application.

6. The method of claim 1, wherein the application value comprises an intrinsic value.

7. The method of claim 6, wherein the intrinsic value is based on a value of impressions associated with the first application.

8. The method of claim 7, wherein the characteristic comprises at least one of a reach associated with the first application, a demographic characteristic associated with the first application, an application category, a historical tendency of users who have downloaded a separate application through the first application to purchase content associated with the separate application, a targeting parameter, and a total lifetime user spend value associated with the first application.

9. The method of claim 1, wherein the application value comprises an intrinsic value, and wherein the exchange rate is based on intrinsic valuation.

10. The method of claim 1, wherein the exchange rate comprises a one-to-one exchange rate, the one-to-one exchange rate being based on a download-for-download valuation system.

11. The method of claim 1, wherein the exchange rate is updated based on a performance.

12. The method of claim 1, wherein exchanging the at least first object with the at least second object comprises managing the exchange between trading partners.

13. The method of claim 12, wherein the trading partners are associated with at least one of the first application, the second application, and a third application.

14. The method of claim 12, wherein the trading partners are identified via an application bank comprising a group of applications, the applications in the application bank being grouped based on at least one of respective application profiles, respective functions associated with the applications, and respective characteristics associated with the applications.

15. The method of claim 14, further comprising, prior to exchanging the at least first object with the at least second object, identifying an intent by the trading partners to engage in the exchange.

16. The method of claim 14, wherein the intent is based on at least one of the application value, respective groupings associated with the trading partners, and respective categories associated with the first application and the second application.

17. The method of claim 1, wherein the exchange is between a plurality of trading parties, and wherein the trading relationships formed by the exchange between the plurality of trading parties are asymmetric.

18. A system comprising:
a processor; and
a computer-readable storage medium having stored therein instructions which, when executed by the processor, cause the processor to perform operations comprising:
adding a first application to a bartering network of applications, the bartering network of applications;
determining an application value of the first application based on at least one characteristic associated with the first application;
identifying a second application for exchanging content impressions between the first application and the second application;
initiating an exchange of content impressions between the first application and the second application, wherein the exchange causes a first content impression associated with the first application to be displayed at the second application and a second content impression associated with the second application to be displayed at the first application, wherein a number of content impressions exchanged is determined using an exchange rate based on the application value.

19. The system of claim 18, wherein the second application is identified based on the application value of the first application.

20. The system of claim 18, wherein the exchange is initiated in response to a bartering request associated with at least one of the first application and the second application.

21. The system of claim 18, wherein the application value comprises an intrinsic value, the intrinsic value being based on a value of impressions associated with the first application.

22. A non-transitory computer-readable storage medium having stored therein instructions which, when executed by a processor, cause the processor to perform operations comprising:
receiving a bartering request comprising an offer to integrate an object associated with a first application into a second application in exchange for integrating another object associated with the second application into the first application;
determining an application value of the first application based at least on a characteristic associated with the first application;
based on the application value of the first application, identifying a second application for bartering respective objects between the first application and the second application;
exchanging at least a first object with at least a second object to yield an exchange, wherein the at least first object is associated with the first application and the at least second object is associated with the second application, and wherein the exchange enables the at least first object to be integrated into the second application and the at least second object to be integrated into the first application.

23. The non-transitory computer-readable storage medium of claim 22, storing additional instructions which, when executed by the processor, result in operations further comprising adding the first application to a bartering network of applications, the bartering network of applications comprising a plurality of applications for exchanging associated objects, wherein each of the associated objects comprises content associated with a specific application and available for integration into a different application.

24. The non-transitory computer-readable storage medium of claim 23, wherein identifying the second application for bartering comprises searching the bartering network of applications for an application to barter with the first application.

25. The non-transitory computer-readable storage medium of claim 23, storing additional instructions which, when executed by the processor, result in operations further comprising sending the at least first object to the second application for integration into the second application, and sending the at least second object to the first application for integration into the first application.
